(19) United States
(12) Patent Application Publication
(10) Pub. No.: US 2005/0237369 A1
(43) Pub. Date: Oct. 27, 2005

(54) Discharging ink for ink jet printing and process for preparing discharged polyester fiber cloth

(76) Inventor: Takahiro Kosaka, Fukui-shi, Fukui (JP)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/519,578

(22) PCT Filed: Sep. 16, 2004
(86) PCT No.: PCT/JP04/13528

§ 371 Date: Dec. 27, 2004

(30) Foreign Application Priority Data
Sep. 30, 2003 (JP) 2002-340024

(51) Int. Cl. G01D 11/00

(52) U.S. Cl. 347/100

(57) ABSTRACT

The present invention provides a discharging ink for ink jet printing, which has excellent discharge properties, is not limited in the dye to be discharged and enables safe and stable processing, in ink jet discharging of a cloth colored in advance, and a process for preparing discharged polyester fiber cloth. The discharging ink for ink jet printing comprises a nonionic surfactant having HLB value of 9 to 16 and ethylene oxide-added mol number of at most 30, guanidine weak acid salt and water. The process for preparing discharged polyester fiber cloth comprises the step of injecting the ink by an ink jet, the step of wet heat treatment or dry heat treatment at 150 to 190° C., and the step of soaping treatment.

### TECHNICAL FIELD

The present invention relates a discharging ink for ink jet printing ink and a process for preparing discharged polyester fiber cloth, more specifically a discharging ink for ink jet printing capable of discharging a cloth containing polyester fiber that is colored in advance and a process for preparing discharged polyester fiber cloth.

### BACKGROUND ART

As a method for discharging polyester fiber cloth, widely employed is the method of discharging by dyeing a cloth with a reducing or alkali decomposing dye and then printing with a discharging paste containing a reducing agent such as sodium hydrosulfite or an alkali agent such as sodium hydroxide.

However, according to this conventional discharging method, a stencil frame for discharging must be prepared. Therefore, problems arise with respect to time and cost and adapting the method for processing of small quantities is extremely difficult. Also, because a stencil frame is used, the patterns that can be formed are limited. Furthermore, from the viewpoint of safety of the workers, many of the discharging agents used in the conventional method are hazardous and particular attention must be paid when using such discharging agents.

As a method that solves the former problem, JP-A-62-232473 discloses a process for discharging using the ink jet printing method. Because a stencil frame is not necessary as in the conventional method, the ink jet printing method seems extremely useful, as the patterns that can be formed are not limited, there are no problems with respect to time and cost and processing is possible in small quantities.

However, because a reducing agent such as sodium hydrosulfite is used as a chemical for discharging ink, the dye that can be discharged is limited to a reducing decoloring dye. Therefore, when full coloring is conducted, the range of color expression is narrow and when high fastness is required for uses such as car seats, there is the problem that fastness is unsatisfactory. Also, because a large amount of the reducing agent must be dissolved in water, problems occur such as long term storage stability of the discharging ink and discharge properties after long term storage become poor.

Also, in recent years, as a method that solves the latter problem, known is the method of mixing guanidine carbonate, which is a relatively safe discharging material, and an inorganic adsorption substance with paste, printing and discharging, as disclosed in Japanese Patent No. 2977546.

It may seem that the conventional problems can be solved all at once if the discharging agent disclosed in Japanese Patent No. 2977546 is applied to the discharging method using the ink jet printing method of JP-A-62-232473. However, in reality, the injection properties of the discharging agent from the ink jet nozzle are unstable and nozzle clogging and dot failure occur. Thus, favorable results cannot be achieved.

Furthermore, JP-A-57-154482 discloses a colored discharge printing method, in which an alkali inorganic compound, a moisture adsorbing agent, a paste, an alkali non-decomposing dispersion dye and a nonionic surfactant having HLB of 14.0 to 19.5 are applied to synthetic fiber that is dyed in advance by alkali decomposing dispersion dye.

However, when the HLB value is 17 or more, the surfactant becomes too hydrophilic that affinity to the dispersion dye that is to be discharged becomes low and discharging may not be conducted depending on the dye.

Also, the discharging agent in the discharging ink is usually transparent or white and therefore, there is the new problem that the injection conditions of the ink cannot be detected or inspected and injection failure cannot be discovered. Consequently, adding a colorant to the ink has been considered, but by adding a colorant, agglomeration and precipitation of the ink tends to occur and injection failure increases.

In this way, an ink jet discharging method, which is excellent in discharge properties, is not limited in the dye that is to be discharged, has high safety and enables continuous and stable processing in ink jet discharging, has not yet been found.

### DISCLOSURE OF INVENTION

The present invention aims to provide a discharging ink for ink jet printing, which is excellent in discharge properties, is not limited in the dye that is to be discharged and enables safe and stable processing, in ink jet discharging of a cloth that is colored in advance, and a process for preparing a discharged polyester fiber cloth.

That is, the present invention relates to a discharging ink for ink jet printing comprising a nonionic surfactant having HLB value of 9 to 16 and ethylene oxide (hereinafter referred to as EO) added mol number of at most 30, guanidine weak acid salt and water.

The discharging ink preferably further comprises an aqueous colorant.

The nonionic surfactant is preferably an ethylene oxide adduct of halogenated phenol.

The content of the nonionic surfactant is preferably 5 to 30% by weight and the content of the guanidine weak acid salt is preferably 0.1 to 5% by weight.

The present invention also relates to a process for preparing discharged polyester fiber cloth, which comprises a step of injecting a discharging ink for ink jet printing comprising a nonionic surfactant having HLB value of 9 to 16 and EO-added mol number of at most 30, guanidine weak acid salt and water by an ink jet on a colored cloth comprising polyester fiber, a step of wet heat treatment or dry heat treatment at 150 to 190° C., and a step of soaping treatment.

The process preferably further comprises the step of applying an ink receiving layer to the colored cloth comprising polyester fiber.

### BEST MODE FOR CARRYING OUT THE INVENTION

The discharging ink for ink jet printing of the present invention is basically characterized in comprising a nonionic surfactant having HLB value of 9 to 16 and EO-added mol number of at most 30, guanidine weak acid salt and water.

By this ink composition, specific decolorable dye does not need to be used and even anti-reducing and decoloring dye can be discharged. Also, ink that is most suitable for ink jet printing can be obtained, as dissolution stability and injection stability are favorable. Furthermore, safety of the ink is high, as toxic substances are not used.

The process for preparing discharged polyester fiber cloth of the present invention is basically characterized in that after an ink receiving layer is applied, when necessary, the discharging ink for ink jet printing of the present invention is injected by the ink jet method on polyester fiber cloth that is colored in advance and then, after wet heat treatment or dry heat treatment at 150 to 190° C., soaping treatment is conducted.

The polyester fiber cloth used in the present invention can be fiber cloth comprising only polyester, which includes normal polyester and modified polyester such as a cation dyeable polyester, and composite fiber cloth of polyester and other types of fiber such as nylon, rayon, cotton, acetate and silk. The structure of the cloth can be woven fabric, knit fabric, plush fabric or non-woven fabric, and is not particularly limited.

The colorant that is applied to the cloth in advance is not particularly limited, but from the viewpoint of efficiently dyeing the polyester cloth, dispersion dye or cation dye is preferably used. Particularly, from the viewpoint that fastness such as light fastness is excellent, dispersion dye is preferable.

For the ink receiving layer, carboxymethyl cellulose, sodium alginate, guar gum, starch, hydroxyethyl cellulose, methyl cellulose, polyvinyl alcohol, polyacrylic acid, polyacrylamide, polyacrylic ester and copolymer of acrylic acid and acrylamide can be used. Of these, carboxymethyl cellulose is preferable, from the viewpoints of excellent fixing stability of the dye, alkali resistance and water retaining properties. The amount of the above material that is applied is preferably 5 to 30 g/m². When the amount is less than 5 g/m², water retaining properties tend to become poor and when the amount is more than 30 g/m², the applied amount becomes too large and the ink receiving layer tends to crack.

In the present invention, a nonionic surfactant having HLB value of 9 to 16 and EO-added mol number of at most 30 is used. When the HLB value of the nonionic surfactant is less than 9, lipophilic properties become too strong that solubility to water decreases and when dissolved in water, a liquid having high viscosity and low surface tension is created. Also, because dissolution stability to water is poor, an oil film-like speck tends to develop and injection properties become problematic. As a result, ink containing such as nonionic surfactant cannot be used as ink for ink jet printing. On the other hand, when the HLB value is more than 16, hydrophilic properties become too high that discharging of dispersion dye and cation dye, which have relatively high lipophilic properties, becomes difficult. Preferably, the HLB value is 12 to 14.

When the EO-added mol number of the nonionic surfactant is larger than 30, discharge properties tend to become poor depending on the dye. Also, because a high viscosity liquid is created even when only an extremely small amount is dissolved in water, only ink having low concentration of the nonionic surfactant can be created, in consideration of problems such as ink injection properties as described above, and the discharging effect cannot sufficiently be obtained. The lower limit of the EO-added mol number is preferably 2 mol, more preferably 4 mol. The upper limit is preferably 20 mol, more preferably 10 mol.

Examples of the nonionic surfactant are ether-type nonionic surfactants such as polyoxyethylene alkyl ether and polyoxyethylene phenyl ether, ether ester-type nonionic surfactants such as polyoxyethylene glycerin fatty acid ester and ester-type nonionic surfactants such as polyethylene glycol fatty acid ester. Of these, from the viewpoint that affinity to dispersion dye is excellent, aromatic ether-type, ether ester-type and ester-type nonionic surfactants are preferable. Furthermore, preferable are ethylene oxide adducts of halogenated (fluorinated, chlorinated, brominated or iodized) phenol, which do not lower the HLB value even when the EO-added mol number is decreased, have favorable water solubility and can be compounded in the ink in a high concentration, from the viewpoint of achieving low viscosity, which is a requirement for ink jet printing ink.

The amount of the nonionic surfactant that is compounded to the discharging ink is preferably 5 to 30% by weight, more preferably 10 to 30% by weight, particularly preferably 10 to 20% by weight. When the amount is less than 5% by weight, discharging tends to be insufficient and on the other hand, when the amount is more than 30% by weight, the viscosity of the ink tends to become high and injection properties of the ink jet may become problematic.

Furthermore, the pH of the ink is made alkali by compounding guanidine weak acid salt to the discharging ink of the present invention. Guanidine weak acid salt is considered to have the effect of promoting discharging, as some dispersion dyes and cation dyes tend to be reduced and discharged in an alkali atmosphere. Also, with respect to cloth that tends to be colored in an acid atmosphere, the effect of assisting discharging is considered to be high, for the reason that by adding an alkali salt, the cloth is placed under an alkali atmosphere and is prevented from being recolored by dye that has been drawn out by the nonionic surfactant.

As the guanidine weak acid salt, carbonates such as guanidine carbonate and guanidine bicarbonate, carboxylates such as guanidine acetate and also, guanidine phosphate and salts of phenol derivative compounds can be used. Of these, from the viewpoint that an ink having high solubility to water, injection stability and storage stability can be prepared, guanidine carbonate is particularly preferable.

The amount of guanidine weak acid salt that is compounded in the discharging ink is preferably 0.1 to 5% by weight, more preferably 0.5 to 3% by weight. When the amount is less than 0.1% by weight, the effect as a discharging aid becomes low and discharging may not be sufficient depending on the dye that is used. When the amount is more than 5% by weight, in the case that the polyester threads that compose the cloth are relatively fine, the area that is printed with the discharging ink is reduced in quantity and in some cases, uneven patterns may appear.

Furthermore, in the discharging ink for ink jet printing of the present invention, an aqueous colorant is preferably added, in order to easily determine the injection conditions of the ink such as clogging and dot failure. As the aqueous colorant, a reactive dye and an acidic dye are preferable, when considering that when a colorant that has high dye affinity to the cloth to which the ink is to be applied is used, the cloth may be dyed and the discharging effect may decrease significantly. Also, the color of the image of the ultimately obtained cloth may change. Particularly, from the viewpoint of excellent dissolution stability to water, a reactive dye is preferable. As the chemical structure of the dye, azo-type and phthalocyanine-type are preferable, from the viewpoints of being relatively easily decomposed and little contamination of the polyester fiber cloth.

The amount of the aqueous colorant is preferably 0.001 to 0.1% by weight, more preferably 0.005 to 0.05% by weight. When the amount of the aqueous colorant is less than 0.001% by weight, the concentration of color by the ink is too low that visual observation of the injection conditions of the ink tends to be difficult. When the amount is more than 0.1% by weight, the aqueous colorant may precipitate and cause nozzle clogging.

The optical density of the ink of the present invention is preferably 2 to 30/g, more preferably 3 to 20/g. When the optical density is less than 2/g, the concentration of color by the ink is low and observing the injection conditions such as nozzle clogging visually or by an optical sensor tends to be difficult. When the optical density is more than 30/g, the amount of the aqueous colorant that is added is excessive and as a result, the dye may precipitate and cause nozzle clogging. The optical density can be measured by a commonly used spectrophotometer.

The viscosity of the discharging ink for ink jet printing of the present invention is preferably 1 to 10 cps, more preferably 1 to 5 cps, at 25° C. When the viscosity is lower than 1 cps, the injected ink drops split when flying and the pattern tends to lack sharpness. When the viscosity is more than 10 cps, injecting the ink from the nozzle tends to become difficult, as the viscosity is high.

The amount of the discharging ink for ink jet printing of the present invention that is applied to the cloth is preferably 10 to 100 g/m². When the amount that is applied is less than 10 g/m², the amount of ink that is applied is too small and the effect of discharging may not sufficiently be obtained. When the amount is more than 100 g/m², the amount is excessive and not only does cost becomes high, but also the ink bleeds and sharpness of the pattern edges tend to be lost.

Furthermore, the discharging ink for ink jet printing of the present invention can be used together with ink for coloring the cloth. By using these together, discharging and coloring can be conducted simultaneously and patterns, such as areas that are discharged, areas that are colored and areas that are both discharged and colored, can be formed freely on the same cloth.

Examples of the coloring ink are water dispersions or aqueous solutions of dispersion dye, acidic dye, direct dye, reactive dye, cation dye and pigment, but are not limited thereto.

The ink jet printing device used in the present invention can be any device that does not heat the ink. Examples are continuous-type devices such as the charged modulation type, the charged injecting type, the micro dot type and the ink mist type and on-demand type devices such as the piezo conversion type and the electrostatic suction type. Of these, from the viewpoints that ink injection stability and continuous injection properties are excellent and the head can be manufactured relatively cheaply, the piezo type is preferable.

In this way, by using the ink jet printing method as the discharging method, processing in small quantities can be conducted and a stencil frame does not need to be prepared. As a result, there are many advantages such as low cost, short delivery period and unlimited patterns and patterns and quantities, which were not available by the conventional methods, can be obtained.

In the present invention, the desired discharged polyester fiber cloth can be obtained by conducting wet heat treatment or dry heat treatment at 150 to 190° C. and soaping treatment after the discharging ink for ink jet printing is injected by the ink jet printing device. The methods for applying the ink receiving layer, wet heat treatment, dry heat treatment and soaping treatment can be conventionally known methods, as described in Examples below, and are not particularly limited.

The treatment temperature for the wet or dry heat treatment is 150 to 190° C., preferably 155 to 185° C., further preferably 160 to 180° C. When the treatment temperature is lower than 150° C., the discharging effect may not sufficiently be obtained and when the temperature is higher than 190° C., the chemicals in the ink receiving layer and the paste may be scorched and stick to the cloth. The treatment time is preferably 3 to 30 minutes, more preferably 5 to 20 minutes. When the treatment time is shorter than 3 minutes, the discharging effect may not sufficiently be obtained and when the treatment time is longer than 30 minutes, treatment is conducted excessively and energy is wasted.

Hereinafter, the present invention is explained in detail based on Examples and Comparative Examples, but not limited thereto. In Examples and Comparative Examples, “part(s)” represent “part(s) by weight”.

### EXAMPLE 1

20 parts of polyoxyethylene chlorophenyl ether (HLB: 13.5, EO-added mol number: 6), 0.02 part of C.I. Reactive Red 24 (azo-type), 3 parts of guanidine carbonate and 76.98 parts of deionized water were mixed-and stirred for 2 hours. The mixture was then filtered under reduced pressure with Toyo Filter Paper No. 5A and subjected to vacuum deaeration to obtain an ink jet printing ink.

(Preparation of Dyed Cloth for Discharging)

A 100% polyester plush fabric cloth was subjected to dip dyeing using an anti-reducing and decoloring dispersion dye, C. I. Disperse Blue 60. Then, carboxymethyl cellulose (Fine Gum HEL-1, available from Dai-ichi Kogyo Seiyaku Co., Ltd.) was applied by the dip nip method so that the amount applied is 20 g/m² and the cloth was dried to obtain dyed plush fabric cloth having an ink receiving layer.

Using the obtained ink and the dyed plush fabric, printing was conducted under the following ink jet printing conditions.

(Conditions for Ink Jet Printing)

Printing device: On-demand type serial scanning ink jet printing device (piezo conversion type)
Nozzle diameter: 50 μm
Driving voltage: 100 V
Frequency: 5 kHz
Resolution: 360 dpi
Amounts applied: 20, 40, 60, 80, 100 g/m²
Printed pattern: matrix pattern for each of the amounts applied

Then, after the printed cloth was dried, wet heat treatment was conducted at 175° C. for 10 minutes. Subsequently, the cloth was washed using a surfactant (Laccol S170, available from Meisei Chemical Works, Ltd.) and thiourea dioxide, dried and brushed.

### EXAMPLE 2

8 parts of polyoxyethylene tristyrenated phenyl ether (HLB: 12, EO-added mol number: 14), 0.02 part of C.I. Reactive Red 24, 3 parts of guanidine carbonate and 88.98 parts of deionized water were mixed and stirred for 2 hours. The mixture was then filtered under reduced pressure with Toyo Filter Paper No. 5A and subjected to vacuum deaeration to obtain an ink jet printing ink.

Using the obtained ink, ink jet discharging was conducted in the same manner as in Example 1.

### COMPARATIVE EXAMPLE 1

10 parts of polyoxyethylene nonyl phenyl ether (HLB: 7.4, EO-added mol number: 3), 0.02 part of C.I. Reactive Red 24, 3 parts of guanidine carbonate and 86.98 parts of deionized water were mixed and stirred for 2 hours. The mixture was then filtered under reduced pressure with Toyo Filter Paper No. 5A and subjected to vacuum deaeration to obtain an ink jet printing ink.

Using the obtained ink, ink jet discharging was conducted in the same manner as in Example 1.

### COMPARATIVE EXAMPLE 2

5 parts of polyoxyethylene styrenated phenyl ether (HLB: 16.9, EO-added mol number: 50), 0.02 part of C.I. Reactive Red 24, 3 parts of guanidine carbonate and 91.98 parts of deionized water were mixed and stirred for 2 hours. The mixture was then filtered under reduced pressure with Toyo Filter Paper No. 5A and subjected to vacuum deaeration to obtain an ink jet printing ink.

Using the obtained ink, ink jet discharging was conducted in the same manner as in Example 1.

### COMPARATIVE EXAMPLE 3

20 parts of polyoxyethylene chlorophenyl ether (HLB: 13.5, EO-added mol number: 6), 0.02 part of C.I. Reactive Red 24 and 79.98 parts of deionized water were mixed and stirred for 2 hours. The mixture was then filtered under reduced pressure with Toyo Filter Paper No. 5A and subjected to vacuum deaeration to obtain an ink jet printing ink.

Using the obtained ink, ink jet discharging was conducted in the same manner as in Example 1.

### COMPARATIVE EXAMPLE 4

3 parts of guanidine carbonate, 0.02 part of C.I. Reactive Red 24 and 96.98 parts of deionized water were mixed and stirred for 2 hours. The mixture was then filtered under reduced pressure with Toyo Filter Paper No. 5A and subjected to vacuum deaeration to obtain an ink jet printing ink.

Using the obtained ink, ink jet discharging was conducted in the same manner as in Example 1.

The inks and cloth obtained in Examples 1 to 2 and Comparative Examples 1 to 4 were evaluated in the following manner. The results are shown in Table 1.

(Ink Viscosity)

The ink viscosity was measured using a BL-type viscometer made by Tokyo Keiki, BL rotor (60 rpm, 25° C.).

(Ink Injection Properties)

One dot pattern was continuously printed for 60 minutes on normal paper and disorder of the dots and clogging were visually observed.
\mathring{∘}: No injection failure for 60 minutes
◯: No injection failure for 10 minutes
Δ: No clogged nozzles but some nozzles having injection failure
×: Clogged nozzles, unable to inject
   (Ink Optical Density)

Spectrum measurement of the ink in a range of 400 nm to 700 nm was conducted using UV2200 made by Shimadzu Corporation and the optical density at the maximum absorption peak wavelength was measured.

(Discharge Properties)

The reflection density was measured before and after discharging using Macbeth RD 918 (made by Macbeth Co.) and evaluation was conducted assuming the reflection density before discharging to be 100%.
\mathring{∘}: At least 50% is discharged for all of the amounts applied
◯: At least 30% is discharged for all of the amounts applied
Δ: At least 10% is discharged for all of the amounts applied
×: Less than 10% is discharged for all of the amounts applied
   (Change in hue after Discharging)

The change in hue was visually observed.
\mathring{∘}: No change in hue before and after discharging for all of the amounts applied
Δ: Some change in hue before and after discharging for all of the amounts applied

×: Change in hue is recognized at once for all of the amounts applied

TABLE 1

| | | | Com. | Com. | Com. | Com. |
|---|---|---|---|---|---|---|
| | Ex. 1 | Ex. 2 | Ex. 1 | Ex. 2 | Ex. 3 | Ex. 4 |
| Ink viscosity (cps) | 2.0 | 2.5 | 2.2 | 2.6 | 1.8 | 1.1 |
| Ink injection | ⊚ | ◯ | Δ | ◯ | ⊚ | ◯ |
| properties | | | | | | |
| Ink optical | 4 | 4 | 4 | 4 | 4 | 4 |
| density (/g) | | | | | | |
| Discharging | ⊚ | ◯ | Δ | X | Δ | X |
| properties | | | | | | |
| Change in hue | ◯ | ◯ | Δ | Δ | Δ | Δ |

### INDUSTRIAL APPLICABILITY

According to the present invention, provided is a discharging ink for ink jet printing, which can be sufficiently used for the ink jet printing method, is not selective of the dye to be discharged and has high safety, and a process for preparing discharged polyester fiber cloth.

1. A discharging ink for ink jet printing comprising a nonionic surfactant having HLB value of 9 to 16 and ethylene oxide-added mol number of at most 30, guanidine weak acid salt and water.

2. The discharging ink for ink jet printing of claim 1, which further comprises an aqueous colorant.

3. The discharging ink for ink jet printing of claim 1, wherein said nonionic surfactant is an ethylene oxide adduct of halogenated phenol.

4. The discharging ink for ink jet printing of claim 1, wherein the content of said nonionic surfactant is 5 to 30% by weight and the content of said guanidine weak acid salt is 0.1 to 5% by weight.

5. A process for preparing discharged polyester fiber cloth, which comprises
a step of injecting a discharging ink for ink jet printing comprising a nonionic surfactant having HLB value of 9 to 16 and ethylene oxide-added mol number of at most 30, guanidine weak acid salt and water on a colored cloth comprising polyester fiber by an ink jet,
a step of wet heat treatment or dry heat treatment at 150 to 190° C., and
a step of soaping treatment.

6. The process for preparing discharged polyester fiber cloth of claim 5, which further comprises a step of applying an ink receiving layer to said colored cloth comprising polyester fiber.
